(19) United States
(12) Patent Application Publication
(10) Pub. No.: US 2023/0361285 A1
(43) Pub. Date: Nov. 9, 2023

(54) ADVANCED HETEROFIBROUS MONOLITHIC WAFER-LIKE SILICON ANODE

(71) Applicant: THEION GMBH, Berlin (DE)

(72) Inventors: Marek SLAVIK, Sered (SK); Andrea STRAKOVA FEDORKOVA, Kosice (SK); Tomas KAZDA, Brno (CZ); Matti KNAAPILA, Lyngby (DK)

(21) Appl. No.: 18/026,267

(22) PCT Filed: Sep. 16, 2021
(86) PCT No.: PCT/EP2021/075551

§ 371 Date: Mar. 14, 2023

(30) Foreign Application Priority Data
Sep. 16, 2020 (EP) 20196550.6
Apr. 9, 2021 (EP) 21167718.2

(51) Int. Cl. H01M 4/38; H01M 4/134; H01M 4/04; H01M 4/1395; H01M 10/0525

(52) U.S. Cl. CPC H01M 4/386; H01M 4/134; H01M 4/04; H01M 4/1395; H01M 10/0525; H01M 2004/027

(57) ABSTRACT

The present invention relates to a negative electrode for the use in alkali-ion rechargeable battery where electrochemically active material is selected from the Group IV semiconductors, the active material forming a heterofibrous monolithic anode body, the anode body comprises at least of 2 layers of aligned and/or stacked and/or interlaced fibers wherein the layers of fibers are spot-fused together at points of their physical contact and further over-lithiated by ex-situ anisotropic chemical and or electrochemical means forming a monolithic wafer-like self-standing over-lithiated alloying type anode where part of the lithium excess is subsequently depleted during forming artificial SEI-layer.

The present invention relates to advanced, ex-situ (before cell assembly), pre-lithiated negative electrode (body) based on group IV semiconductors according to claim 1. The inventive silicon anode as an alkali-ion battery and preferably to a lithium-ion secondary battery exhibits self-standing and/or heterofibrous and/or wafer-like and/or monolithic structures with high degree of structural ordering. This invention offers the possibility to engineer thick silicon electrodes featuring tailored weak and rigid points in its structures to buffer the volumetric expansion during charge/discharge cycles in a predicted manner, overcoming the uncontrolled volumetric expansion in the state of art silicon anodes.

Definitions of the invention are given after the “object of the present invention” for each aspect of the inventive anode.

From US20180331341A1 a spun silicon-based mat is known made from a mixture of a liquid silicon precursor and polymer, wherein lithium is introduced in the silicon matrix of the resulting nanotubes of the spun mat.

Due to the rapid growth of e-mobility sector together with portable smart electronic equipment, there are growing demands for advanced secondary batteries with higher energies as well as high charge rate acceptance which address the actual challenges originated from the users of BEV battery powered electric vehicles which request much higher operation radius on single charge and shortest charging time possible defined here as ≤30 min from 15% SoC to 100% SoC (State of charge) with negligible negative effect on the cycle life defined as SoH (state of health)—The SoH indicates the ratio of the currently maximum usable capacity to the nominal capacity.

Li-ion battery with high cycle life and high charge rate acceptance is in direct conflict at least with the present types of alkali-ion anodes which are mostly based on Li+ intercalation reaction into graphite. The slow Li+ diffusion on intercalation into graphite together with the presence of concentration polarization gradient further restrict accessibility of Li+ by hampering the transport rate of Li+ from electrolyte to anode. This phenomenon then exceeds Li diffusion-intercalation rate and induce accumulation of more charge carriers on the anode surface and drives the anode potential below 0 V. This is the area where lithium plating is kinetically more favorable than Li+ intercalation reactions and as the working potential of graphite is close 0.1V a metallic Li deposition occurs and subsequently cell degradation and safety issues.

The growing sector of portable electronic device, recently, coinciding with the trend towards “small” and “compact” energy carriers hereby defined as batteries with desired high (>750 Wh/l) volumetric energy density, and “light” defined as batteries with desired high (>300 Wh/kg) gravimetric energy density are fulfilled by the inventive anode. There is mismatch in understanding the definition of “high energy battery” terminology where the most preferable demand to the battery is to have high gravimetric energy in Wh/kg. But in reality, its opposite a volumetric capacity Wh/l is more demanding due the fact that available space: As example serve the available space/volume for insertion of battery into the smartphone, notebook or in electric car platform, for which the most limiting factors is the need of battery with both high volumetric and gravimetric energy density hereby defined as compact & lightweight battery.

Silicon as is one of the most promising type of anode for the post-lithium batteries which are based on alloying redox reactions with theoretical room temperature gravimetric/volumetric capacity in de-lithiated (discharged) state 3579 mAh/g, 8334 mAh/cm3 and lithiated Li3.75Si (charged) state 1857 mAh/g, 2193 mAh/cm3, while average discharge potential of 0.4 V vs. Li/Li+. Compared to the most common type of anode—graphite hereby defined as state-of-the-art anode used in commercial Li-ion cells—is defined as gravimetric (graphite) 372 mAh/g vs. (silicon) 3579 mAh/g and volumetric (graphite) 837 mAh/cm3 vs. (silicon) 8334 mAh/cm3 capacity.

Lithium metal anode volumetric capacity in fully discharged state is 0 mAh/cm3 so all lithium was stripped down from e.g., a Cu foil during discharge and transferred towards the cathode. So, lithium in fully charged state has a capacity of 2061 mAh/cm3 compared to silicon which has in fully discharged state a capacity of 8334 mAh/cm3 and fully lithiated—charged state 2193 mAh/cm3. So those numbers disclose advantages of using lithiated silicon anode instead of LMA (lithium metal anode). This is because theoretical volumetric fluctuation of lithium metal is 100% represented by average 0.205 mAh/cm2 per 1 micron of thickness. Thus, a LMA anode is dimensionally unstable. So, on discharging (stripping) the thickness of lithium metal foil decreases where opposite on charging (plating) increase. In comparison to graphite which is the most commonly used anode material, all volumetric fluctuations during cycling of the inventive anode are compensated inside the internal voids/porosity (≈30% of the volume) of anode with only minor changes of anode thickness.

LMA foil is a host-less anode. Thus, in order to charge it large irreversible losses are present due the SEI (solid electrolyte interphase) formation, but the most important factor is a lithium defragmentation and subsequently expansion of SEI layer which is even for use of advanced electrolytes 50% and progressively increasing on each cycling (lithium consuming). So totally the minimum theoretical volumetric fluctuation for LMA is now in best case scenario 150% vs. 276% for silicon but the real situation is different. LMA (foil) is preferably used in excess due to the Li+ consuming SEI buildup during cycling. So, when all available Li+ is consumed the cell is dead.

In order to deal with cycle life in realistic Li-ion batteries with LMA commonly used excess is 200%. So, the comparison of the theoretical volumetric capacity of silicon 2193 mAh/cm3 with the best possible scenario LMA foil with only 100% excess results in a reduction by a factor of 2 to a theoretical capacity of 1031 mAh/cm3. Because thereof, lithium excess within the anode/cell compartment represents dead weight/volume, its excess in battery is mainly because to compensate its consumption and enhance cycle life. Now when we compare realistic LMA anode 1031 mAh/cm3 with graphite and its volumetric capacity of 837 mAh/cm3 it's clear that if we add expansion contribution from SEI on LMA 50%, it's evident that using claims like “lithium metal is holy grail of battery” it's just lack of understanding of the basic electrochemistry and cell-battery-module-pack-system.

Important factor for the solid-state battery with LMA anode is a necessity of use specific device capable to provide uniaxial pressure over the battery module. This is because LMA is dimensionally unstable so in order to exchange ions lithium metal foil needs to be pressed against solid electrolyte which then results to additional dead weight/volume gain. However, this time not from the cell components but due the additionally auxiliary components related to battery module or pack and because of stack In order to distribute forces such as 10 MPA homogeneously over the entire surfaces. Therefore, a realistic cell design would result in a further decreased energy content of around 18% and also significant safety concern due the presence of pre-compressed battery modules within e.g., an electric car which during crash accident could release extreme energies present in such batteries.

In the scope of the previous analysis the inventive ex-situ pre-lithiated heterofibrous silicon anode with preferably an artificial SEI layer, having mixed ion-electron conductivity is a new and viable solution for the next generation batteries, capable to accept high charge rates and realize ultra-compact batteries with capacities over 1200 Wh/l and 350 Wh/kg with Li-rich LLS cathode.

It's clear that the higher density of silicon would offer 10 times higher volumetric energy content than graphite anodes, but for the cost of high volumetric expansion on lithiation defined as (graphite) 11.2% and (silicon), 276% where the challenge is the nature of silicon expansion. (See ELSEVIER Journal of Industrial and Engineering Chemistry, Journal Volume: 74, Journal Issue: 25; Journal ID: ISSN 1226-086X page number 216-222). This is a highly anisotropic process so the point of interaction/entering of electrons/ions into reaction with silicon and subsequently alloying reaction proceed different from the traditional intercalation type anode—graphite.

The low cost of silicon as second most abundant element in the Earth's crust (about 28% by mass) after oxygen in combination with high volumetric/gravimetric energy of Si offers significant benefits towards the use in next generation energy carriers—batteries. Si is a group IV type semiconductor with conductivity of 1.6×10−3 S/m and Li+ diffusivity of 1.9×10−14 cm2/s, but the Li+ diffusion in Si proceeds by different speeds according to the Si crystal orientation and thus the direction is 3D. While the critical force (1) in <100> and <111> orientation is about 40% and 15% lower than in <110>), which means that lithium atoms have a preferred diffusion rate in <110> direction. Thus, this discrepancy in diffusion would result in fast capacity degradation due the non-uniform anisotropic expansion/contraction of the silicon at particle level and subsequently on electrode. This results in different rates of lithiation within the internal electrode structures, where e− conduction paths are provided dominantly by physical interaction between active mass Si, binder and conductive additives. The points of Si interaction with Li+ and e− would define the reaction kinetics and thus as Si anode cycling proceed by repeatable charge/discharge cycles, the position of Si particles within the present anode structures isn't rigid. Therefore, each shrink/expansion on subsequent cycling will redistribute internal ion/electron conduction paths which is due the presence of polymeric binder flexible. Thus, the point of interaction of silicon with e− always changes due the complex nature of slurry-based Si anode where active Si particles must interact with binder and conductive additives to create an electron and ion conduction path.

Present technological solutions of the silicon-based anodes are based on using Si as minor additive into existing slurry-based anodes where internal porosity of the anode is used to compensate volumetric fluctuation during cycling. Because of existing limitation originated from the preferential usage of slurry-based anode such volumetric changes are only partially compensated by internal voids of the anode, at which the most of the pressure build up within the anode is converted into mechanical forces. This further destabilizes structural connection between Si-graphite-binder-conductive additives. In a traditional silicon-based Li-ion batteries e− conduction path is provided by the interaction of silicon with billions of conductive nanoparticles which transport e− to and from the electrode. Because a morphological change of silicon-based anode occurs there isn't a steady state Li—Si alloying point. So, the direction from which lithium will enter into crystallographic structure of silicon while forming amorphous LixSi phase and the presence of local Si anisotropy will further result in deformation and subsequently redistribution of mechanical forces and finally cracking and delamination of Si structures. The Si surface is therefore exposed to the electrolyte and further consumes available electrolyte and Li+ to create a new SEI layer(s). This leads to irreversible capacity loss as well as impedance gain, resulting in evolving of excessive heat during cycling, whereby the most limiting factor is fast charging rate (Solid Electrolyte Interphase layer).

To solve the above mentioned problems, it is an object of the present invention to provide a negative electrode—heterofibrous, lithiated silicon anode preferably exhibiting hierarchical electrode porosity, for an alkali-ion battery exhibiting an significantly improved cycle life, high coulombic efficiency, gravimetric and volumetric energy density, active mass utilization level and innovative production methods characterized as preferably solvent-free and/or binder-free and/or drying-free and/or slurry-mixing & degassing-free and/or slurry coating-free and/or anode current collector foils to tab welding-free and/or calender-free anode (and process of preparation) which together brings a high energy, cost efficiency and environmentally positive effect of such advanced silicon anode. High charge rate acceptance of heterofibrous, preferably anisotropically, lithiated, (preferably n-type) silicon wafer anode defined here at cell level as full charge of cell from 15% SoC to 100% SoC in preferably ≤12 min would have global impact on the alkali-ion battery market. (Monolithic) Wafer may mean: self-standing and/or heterofibrous and/or silicon (or in general group IV semiconductor)-based anode and/or unified anode body made from heterofibrous silicon material having preferably tailored hierarchical open porosity.

Self-standing may be understood as a structural property. Such anode is capable of keeping its structure without external support such as an external backbone that only serves structural rigidity purposes and would take away space in the anode which could otherwise be used for the active material. Just as it is expected from a wafer.

The term “heterofibrous” fibers refers to a possible variation in length and/or diameter of the same.

Monolithic may refer to the shape and/or structure of the active anode material made from layers of fibers by fusing them together in the inventive way which results in a unified active anode material body.

The task is solved according to the present invention by an anode according to claim 1.

The inventive negative electrode may be used in an alkali-ion rechargeable battery and comprises an electrochemically active material of the anode wherein the active material is selected from the Group IV semiconductors and/or the active material is provided as a heterofibrous and/or wafer-like and/or self-standing and/or monolithic anode body and/or the anode body comprises at least 2 (individual/discrete) layers of aligned and/or stacked and/or interlaced fibers and/or the at least two layers are arranged parallel on top of each other and/or the layers are interconnected at multiple discrete interconnection sites, preferably interconnection points, via metallurgical bonds and/or the metallurgical bonds comprise or consist of Li-Group-IV-semiconductor-alloy and/or lithium or a mixture of the two and/or the discrete interconnection sites are distributed across the anode body, preferably discretely distributed over the, more preferably whole, area of the layers and/or the metallurgical bonds extend in an out-of-plane direction with respect to the individual layers and are spacers between the layers, and the anode body, in particular its layers, is/are preferably unevenly lithiated with non-lithiated, deficiently lithiated and stoichiometrically lithiated areas.

The inventive electrode may also be described as a negative Li⁺ host type alloying electrode.

The present invention may also refer to an anode comprising at least 2 (individual/discrete) layers of aligned and/or stacked and/or interlaced fibers wherein the at least 2 layers are arranged parallel on top of each other wherein the layers are interconnected at multiple discrete interconnection sites, preferably interconnection points, via metallurgical bonds, wherein the metallurgical bonds comprise or consist of Li-Group-IV-semiconductor-alloy and/or lithium or a mixture of the two wherein the metallurgical bonds extend in and out of the plane direction with respect to the individual layers and are spacers between the layers, the gaps between the layers formed by the spaces can be filled with the silicon-lithium alloy formed during charging/lithiation of the anode, wherein the anode comprises an SEI-layer the volume/extension of which is adapted to the volume of the anode in the maximum lithiated state. Such SEI-layer may be formed by over lithiation of the anode and subsequent formation of an artificial SEI-layer via dopants or electrolytes which consumes the excess of lithium (preferably from about Li₂₁Si₅ to about Li₁₅Si₄) while the silicon lithium alloy has its maximum volume.

Thereby, the SEI-layer does not experience forced expansion during charging of an according battery with such anode.

In the scope of our invention, we apply an innovative method for the producing of ex-situ pre-lithiated silicon structures of higher order—monolithic heterofibrous anode which allow to finely tune the content of lithium within the silicon anode active material to suit lithium free or lithiated cathode. Since all subsequent processes are applied at the wafer (anode active material body) level, all irreversible losses originated from SEI forming is compensated internally by ex-situ method.

Unevenly distributed lithiation or anisotropic lithiation of the layers comprise non-lithiated, deficiently lithiated and stoichiometrically lithiated areas.

Spot-fusing, which may also be called interconnection sites as a synonym, means metallurgical bonds from Li-Group-IV-semiconductor-alloy and/or lithium or a mixture of the two, the layers are interconnected at multiple discrete points by the metallurgical bonds and the discrete points of interconnection are spread across the anode body, hence over the whole area of the layers.

According to the present invention discrete may mean separated from each other or individually introduced or having space between them or a combination the same.

Interconnection sites are located between the layers and may extend into the layers for improved anchoring.

Spot-fusing at certain positions may additionally guide the subsequent distribution of LiₓSi_{(y)} in the anode during cycling controlling the way how LiₓSi_{(y)} will redistribute in the anode. The mechanical stress coming from cycles of lithiation and de-lithiation charging/discharging can therefore be distributed.

“Anisotropy” is a way how the deposition of Li in the anode as LiₓSi_{(y)} can be predicted and guided during further repeating charging/discharging cycles. It's like chassis of modern car in which structure engineers insert weak spots which will guide during an accident how the chassis will deform and absorb the energy from the crash. The spot fusing may do the same inserting weak spot into structurally rigid LixSi anode body.

The metallurgical bonds are preferably introduced by electrochemically induced Li fusing or introduction of molten lithium. Locations, distribution, shape, size and numbers of those fused spots can be extracted from the analysis of current distribution non-uniformity within LiₓSi_{(y)} anode. Techniques for the current analysis include galvanostatic, potentiostatic and impedance spectroscopic measurement techniques. Furthermore, the distribution of the fused spots can be derived via in-situ and/or ex-situ imaging techniques like scanning electron microscope and transmission electron microscopy, whereby elemental mapping via energy-dispersive X-ray spectroscopy elucidates the location of metallurgic bonds and the presence of density gradients.

Tortuosity of the anode is directly linked to the accessibility of the straightest and shortest possible electron and ion conduction paths established for Li+ by electrolyte present within the internal voids of electrode and for e− direct physical interaction of active mass with conductive additives such as carbon black or conductive polymers and/or its combination with. Traditional slurry-based electrode lack of structural ordering which is crucial for obtaining efficient electron and ion paths while monolithic silicon anode with high degree of structural ordering defined as hierarchical structure. This consist from layers of aligned silicon fibers stacked into the monolithic anode structure and is therefore able to establish efficient paths. Monolithic silicon anode with ordered porosity replaces traditional mediated electron conduction paths characteristic for slurry-based electrodes which are based on direct physical contact between silicon, conductive agents, binder and current collector foil by the inventive direct lithium-fused fibrous low resistive heterofibrous silicon anode body. This type of open structure allows fast charging of the anode beyond the critical limit of the existing intercalation type anode present at 80% SoC.

The artificial SEI layer may be made by the following steps.

Interconnected layers of Si-fibers are lithiated (over lithiated) to Li₂₁Si₅. Such lithiation may be conducted under elevated temperature preferably above 100° C. under a protective solvent such as e.g., linear, branched or cyclic alkanes (Adv. Energy Mater. 2019, 1902116; DOI: 10.1002/aenm.201902116). Suitable solvents may be binary and or ternary mixtures of polar and non-polar solvent or solvents where more preferably non-polar solvent is hydrocarbon such as decane and polar solvent with boiling point >130° C. such as DEGDME diethylene glycol dimethyl ether.

The (over) lithiated Si-layers are then treated with dopants to form an artificial SEI layer, preferably in a maximum lithiated stated of the Si-anode. The reaction of the dopants with the lithiated anode reduces the lithium content. A stoichiometry of Li₁₅Si₄ may be reached by/after artificial SEI formation which is stable at room temperature. Since the SEI layer is induced artificially after the lithiation of the Si-Anode the aSEI layer has less imperfections (cracks, weak spots, thickenings, . . . ) since there is only SEI formation at the end of the initial lithiation process and hence no volume expansion happens after SEI formations occurs (as it is the case if SEI is formed before or during initial lithiation process). The protective solvent prevents formation of the thick SEI layer at an earlier stage of/during lithiation.

SEI formation may be conducted in the protective solvent into which liquid/dissolved and/or gaseous dopant (e.g. As-, P-, (H)F-compounds) such as group V pnictogens or low concentration electrolyte are introduced alternatively or additionally the SEI-layer may be introduced by reaction of the over-lithiated Li₂₁Si₅ with an electrolyte such as used in a final battery. Such electrolytes may be chosen from e.g., ceramic solid electrolytes, polymer electrolytes, ionic liquids as known to the person skilled in the art. Upon contact of the dopant and/or electrolyte with the (over) lithiated Li₂₁Si₅, lithium reacts with the dopant and/or electrolyte forming a tailored (artificial) SEI layer containing e.g., Li₃P, Li₃As, Li₄As and/or LiF depending on the used dopant and/or electrolyte. After consuming part of the Li from Li₂₁Si₅ by reaction with dopant and/or electrolyte and/or dopants and/or electrolytes room temperature active alloy (such as Li₁₅Si₄) remains as a capacity of the Anode. The resulting artificial SEI layer experiences mixed ion-electron conductive properties. The amount of Dopant in the Si-Layer can be adapted to the amount of Li present in the Li₂₁Si₅ to yield the desired Lithiation degree.

This method reduces the loss of Li during the initial formation of the SEI layer compared e.g., to the classical lithiation of the final battery by initial charging. Furthermore, since the SEI is formed when the LiₓSi_{(y)} species, such as Li₂₁Si₅, has his higher volume, no crack of the SEI can occur by the volume expansion of the silicon, which is more often the case during silicon anode operations

Common Li-ion cells contain a certain amount of lithium inserted/intercalated into NMC cathode which means that battery is in fully discharged state where all lithium is at the cathode side. In order to move Li⁺ from the cathode into the anode, the anode needs initial charging, however during this process, a high irreversible loss of Li takes place. This Li is consumed by the SEI buildup as a non-active part of the SEI layer and because of the high reactivity of lithium, thick highly resistive R_{SEI}) is formed. In additional, this affects the R_{ct} high charge transfer resistance (kinetics of electrochemical reaction). This common in-situ process uses only Li which is present in the cell as part of the energy storage matrix. In case of a Si-anode the lithiation is done in-situ such as by mixing of suitable Li precursor capable to be part of the slurry or to be sprayed over the surface of electrode to be lithiated and subsequently activated by calendaring, cracking the protective layer of SLMP as “2010 DOE Vehicle Technologies Program Review” P. I. Marina Yakovleva Co-P. I. Dr. Yuan Gao FMC Jun. 8, 2010 (https://www.energy.gov/sites/prod/files/2014/03/f11/es011_yakovleva_2010_o.pdf). However, the in-situ lithiated electrode will lead to a super expensive method, since building a protective layer over the micronized lithium metal powder introduced ex-situ during cell assembly but has to be activated subsequently.

In contrast the preferred ex-situ introduced lithium which was supplied externally can be a. provided in excess, therefore allowing to achieve 100% of the theoretical cell capacity and b. provide a uniform SEI layer with little to none cracks, weak spots, thickenings, etc. since formation of the SEI layer is conducted in a maximum expanded state (by volume) i.e. (over) lithiated state of the anode—Li₂₁Si₅. This method may also avoid inclusions of SEI layer material inside the LiₓSi_{(y)} body.

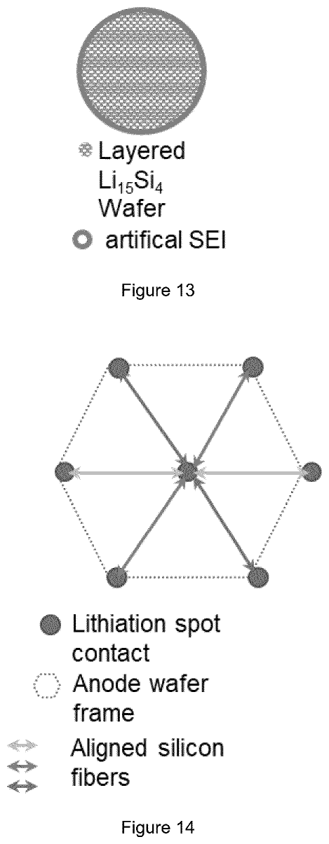

Traditionally existing silicon-based anodes are based on intrinsic silicon where nano-particles have various shapes such as 0D, 1D or more complex 3D host structures for silicon or micro-meso porous 3D silicon or etched silicon anode body. Where for 0D silicon particles having under critical diameters which prevents particles to rupture during lithiation (expansion) is having protective carbon coating on its surfaces where such coating is more preferably carbon. This type of protective coating represent barrier for lithium initiated self-fusing of surrounding silicon structures in close physical contact. Whereas traditional silicon anodes protective coating based on partial oxidation of the surface of silicon and or carbon coating those processes are applied to deal with pyrophoric nature of nano-sized silicon particles and ability to be processed as slurry with suitable solvent without significant side reaction. The presence of barrier layers between silicon particles in slurry-based electrode doesn't allow lithium to efficiently propagate self-fusing process over the full electrode. Slurry based silicon electrodes keep their internal electron conduction paths dominated by physical contacts between active mass particles—silicon and surrounding particles, conductive additives such as 1D shape as CNT and or 0D as carbon black and polymeric binders where our invention of heterofibrous anisotropically pre-lithiated monolithic silicon anode use preferably advantageous lithium initiated self-fusing process of silicon to build innovative fully interconnected monolithic 3D (wafer-like) anode. Preferably physical contacts mediated by conductive additives and polymeric binders typical for slurry-based silicon anode are completely eliminated by (full) metallurgical bonds/joints created by fusing lithium with cross-contacted silicon fibers and/or where pre-lithiation, artificial SEI (FIG. 13)

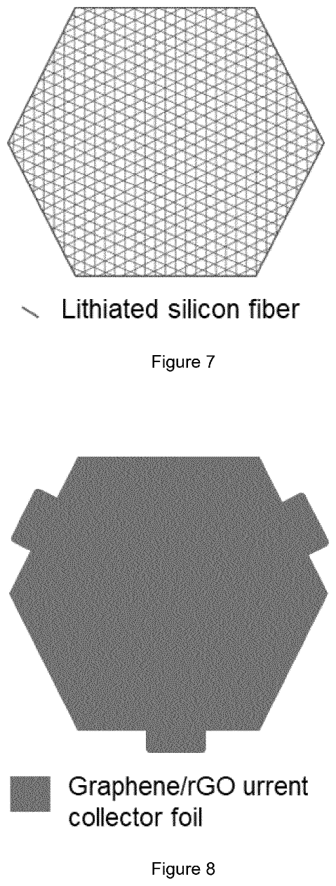

In an embodiment an object of the invention is an engineered hetero-fibrous and/or monolithic silicon anode body with functional anisotropy represented by the introduction of specific areas (FIG. 7) into the monolithic silicon body which further comprises combinations of structurally rigid (fused parts of the lithiated layers) and weak spots (non-lithiated and or partially lithiated and or fully lithiated and/or over-lithiated parts of the layers). They together may form an engineered electrode superstructure capable to re-distribute volumetric fluctuation of silicon by allowing weak areas to absorb and redistribute it. Those areas may preferably be oriented in plane of electrode to accommodate volumetric changes and re-distribute it, preferably according pre-defined direction where rigid spots are preferably oriented out of plane and interconnect silicon layers. The diameter of the fused spot or line is preferably in the range of 1 to 1500 μm, more preferably in the range of 375 μm. The outer-side distance of the fused spots or lines is preferably in the range of 50 to 3000 μm, more preferably in the range of 750 μm, whereby the fusing spots and/or lines may feature a certain geometric pattern (spiral, star-shaped, hexagonal, etc.) and/or an uneven distribution.

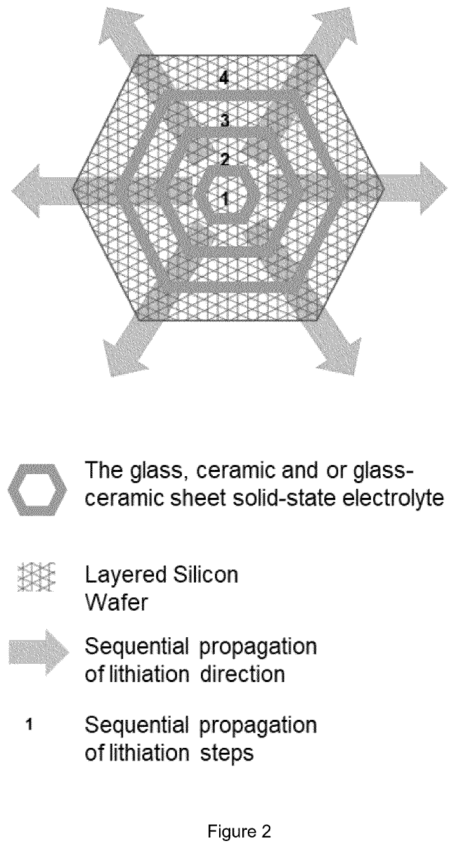

The fused spots may be provided as part of the structural integrity of the (wafer-like) stack of layers of Si-fibers. Thus, the number of fusing spots may be chosen accordingly to provide for at least an initial support of the overall anode structure. Anisotropic lithiation may be provided by the above stated discrete lithiation process, since Lithiation is oriented within and/or between the provided layers and is therefore provided with a defined plane and direction of extension. The spots may also add high degree of structural strength and partial flexibility to deal with silicon anisotropy on cycling. Additionally, to the (anisotropic) fusing spots FIG. 7 preferably an anisotropically aligned Si—Li alloy-pattern is provided on and within the (wafer-)structure/layer structure/Si-fibers with preferably lithiated parts distributed over the total anode body (wafer)/layer structure and non-lithiated or Li deficient parts in the first process step distributed over the total anode body (wafer)/layer structure at the same time (see FIG. 2 for example).

Such alignment may also be called functional anisotropy by lithiation and forming Li—Si alloy with structural aka. flexural modulus gradient between spot-fused pillars. Lithiation may generally be established by a print-fuse method with liquid lithium and/or its alloys and/or electrochemical lithiation and/or its combination where more preferential it's a two-step lithiation.

Spot-fused may mean:
the layers are interconnected at multiple discrete points by metallurgical bonds and/or
connected in individual single places and/or areas and/or lines
at the discrete points of interconnection Li-Group-IV-semiconductor-alloy and/or lithium or a mixture of the two is provided as the metallurgical bond material, and/or
the discrete points of interconnection are distributed across the anode body, hence over the whole area of the layers and/or
the layers are spaced apart from each other, preferably by the material of the discrete points of interconnection and/or
the metallurgical bonds extend in an out-of-plane direction with respect to the individual layers,
   the meaning of spot-fused goes beyond a mere connection in single dots and may also include lines and/or areas and/or pillars. Those may have the properties as outlined in thus patent application.

According to a preferred embodiment distribution or degree of lithiation within the layers varies, wherein the degree of lithiation of the anode body cross to the plane of extension of the layers is similar

According to an embodiment the present invention is directed to a negative electrode for the use in an alkali-ion rechargeable battery, wherein the electrochemically active material of the anode is selected from the Group IV semiconductors. The active material may be provided as a heterofibrous and/or wafer-like and/or self-standing and/or monolithic anode body. The anode body comprises at least 2 layers of aligned and/or stacked and/or interlaced fibers which are spot-fused together by the presence of lithium at multiple discrete points of their physical contact forming individual Li-Group-IV-semiconductor-alloy (e.g., LiSi-alloy) bonds between the layers. Alternatively, or additionally to the spot fusing the anode body, in particular the layers, are anisotropically lithiated. The spot fusing may at least in one aspect of the present invention represent at least a part of the anisotropic lithiation. The anode as mentioned above may contain an excess of lithium, at least in a charged state, within the anode body which may not necessarily be involved in the bonding of the layers. This additional lithium may be present as e.g., charge carrier, preferably within the individual layers.

It is an objective of the invention to introduce an innovative method how to efficiently deal with the volumetric fluctuation of the silicon-based anode by introducing strategically positioned weak and rigid spots—structures which together work in synergy. This might be visualized in a similar manner as structural weak spots originally placed into chassis of a car by engineers to save life by absorbing impact forces during auto-crash and convert it into mechanical deformation of the chassis and surrounding structural parts of car. Weak spots may also be called expansion/shrinkage zones into which the anode material may expand during the lithiation (charging) and shrink on de-lithiation (discharging).

It is a preferred objective of the invention to introduce structural and/or material anisotropy represented by a variation of anode density caused by lithiation (and/or lithium alloy formation) in the heterofibrous silicon anode body (wafer) and/or electrical anisotropy represented by the conductive (lithium, lithium alloy) lines, dots, areas, pillars (in total hereby called pillars, see e.g. FIG. 2) pillars preferably oriented perpendicularly to the electrode base (to the direction of extension of the silicon fiber layers).

In an embodiment an object of the invention is a production of well aligned and/or interlaced and/or stacked self-standing layers comprising (preferably consisting of) silicon nano or microfibers and or silicon nano or micro rods, thus crystalline and/or amorphous and/or poly-crystalline silicon, preferably from suitable hydrogenated silicon precursors which are preferably liquids within the operating window of nano and or micro fibrous production apparatus, preferably defined between m.p. −55° C. to b.p. 420° C. Silicon precursors include, but are not limited to cyclic silanes (SiₙH₂ₙ, where n>3) e.g. cyclohexasilane Si₆H₁₂, (m.p. +16.5, b.p. +226° C.) or acyclic silanes (SiₙH₂ₙ₊₂ where n>3) such as hexasilane Si₆H₁₄ (m.p −44.7° C. to +b.p. 193.6° C.). The general concept how to convert silanes into crystalline or polymer silicon and thus fibers can be found e.g. in ACS Applied Materials and Interfaces, Journal Volume: 4; Journal Issue: 5, pages 2680-2685; Journal ID: ISSN 1944-8244 (solution-based synthesis of microcrystalline silicon). According to an embodiment, the Si precursor may also carry dopant and or dopants which is/are crosslinked with the Si precursor e.g. forming a co-polymerized Si/dopant solution prior to a fiber spinning process or growing Si rods, wires having nano and or micro dimensions.

The above and the following information of Si and Si-fibers are also meant to apply to any group IV semiconductor or a mixture of them.

A suitable liquid silicon precursor could also be poly(silanes) such as dimethyl-polysilane (DMPS), deca-phenyl-penta-silane (DPPS) and poly-methyl-phenyl silane (PMPS) and/or suitable n-type dopant could be phosphorus bromine PBr3.

A first possible method for the production of the silicon layer is electrospun of a (polymeric) solution onto a substrate, and subsequent thermal decomposition by means of a heating treatment and/or laser treatment and/or microwave treatment, in order to obtain a silicon layer made from rods and/or wires having nano and or micro dimensions, which can be doped or not. The same operation is carried out by electrospinning a second layer of (polymeric) silicon precursor and subsequently thermally decomposition to obtain a second silicon layer. The operation can be repeated X times to obtain X stacked/interlaced silicon layers.

A second possible method is based on carbonaceous seed carriers decorated with suitable catalyst (e.g., gold, silver nickel, etc.) capable to form intermetallic compound with silicon on the growing process. Those seed carriers are in the shape of 0D ((silicon)-nanocrystals, quantum dots) 1D (CNT) and/or 2D (graphene, mxenes, silicon nanosheets) and/or 3D (reduced graphene oxide foam, MOF) carbon-based materials. Those seed materials decorated with the mentioned nucleation seeds may be aligned by dielectrophoresis at the top of a solution containing the co-polymerized Si/dopant mixture, which can be dissolved in hydrocarbon or mix of hydrocarbons, such as paraffin for example. A system of current collectors can be implemented in different geometry, for example such as a hexagonal one, containing 3 cathodes and 3 anodes. The alignment of these seed carriers will create an electronic percolation network which will short circuit the cathode/anode pairs. This short circuit will create heat by the Joule effect at the surface of the seed carriers, which triggers the thermal decomposition of the silicon precursor and a silicon layer made of rods and/or fibers, and/or wires having nano and or micro dimensions will be obtained. In addition, this silicon layers can be doped by various n-types (e.g., phosphorus) or p-type (e.g. boron) via addition of suitable dopant precursors (e.g. B2H6, pnictogenes, etc.) in the precursor solution. Several layers can be obtained by stacking up the dielectrophoresis electrodes in a hexagonal system by an electric insulator, in order to obtain a stack of electrodes.

The good production of the described anodes can be monitored by scanning electron microscopy to confirm the morphology of the silicon monolith, as well as micro tomography to ensure the good distribution and position of the fusing point. Regarding the performances of the anode, usual galvanostatic cycling method can be implement as well as cyclic voltammetry, where the anodic and cathodic peaks should be included in less than 0.2 V, translating the good kinetics of the electrochemical reactions, and thus an appropriate morphology of the silicon anode for ionic and electronic diffusion, as well as efficient charge transfer phenomena. As the ex-situ lithiated anode (Li₁₅Si₄) represents the fully charged state of an electrochemical half-cell based on the fabricated silicon anode with a suitable lithium free cathode e.g., sulfur, the electrochemical cell features an open circuit potential greater than 0 V, as for the example sulfur a potential of 2.1 V is observed. To monitor the full lithiation of the ex-situ fabricated Li₁₅Si₄ anode (e.g., of 100 mg) the initial discharge reaches the complete theoretical capacity (185 mAh in the case of a 100 mg Li₁₅Si₄ anode). The beneficial build-up of the ex-situ fabricated SEI is shown via repeated charging/discharging of the such fabricated anode without losing capacity due to the formation of lithium consuming in-situ SEI build up. The structural integrity of the ex-situ SEI in combination with the anisotropic lithiation results in a capacity retention of up to 90% of the initial discharge capacity over up to 1,000 charge/discharge cycles at current densities 3 C. Another approach visualizing the anisotropic Li distribution is achieved via operando analysis of the charge distributions via X-ray microdiffraction during charging/discharging, especially during the initial discharge (according to ACS The Journal of Physical Chemistry Letters, Journal Volume: 1; Journal Issue: 14; Pages 2120-2123; Journal ID: ISSN 1948-7185).

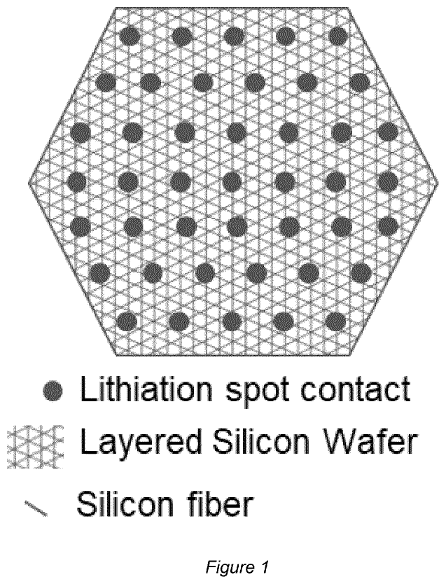

Another object is a spot-fusing of the resulting monolithic heterofibrous silicon anode e.g., initiated by the alloying reaction between lithium and/or binary lithium alloy and or ternary lithium alloy and or lithium salt. A suitable solvent for alloying Li with Si and capable to solubilize lithium salt where more preferably lithium salt is LiTFSl and suitable solvents are e.g. binary and or ternary mixture of polar and non-polar alkane solvent where more preferably non-polar solvent is hydrocarbon such as decane and polar solvent is diethylene glycol dimethyl ether where boiling point of solvents is higher than 130° C. and where molarity of LiTFSl within the electrolyte is ≤0.75 M where more preferably 0.25 M. Preferably pre-lithiation is introducing structural lithium (e.g. Dots/lines—FIG. 1, 2, 3) before setting up a battery so pre-lithiated silicon anode is a structure which contain lithium and/or Li—Si alloy.

According to an embodiment of the previous objects this invention includes environmentally positive electrode which is fabricated from a slurry free process and/or is not based on an anode material slurry and/or binder free and/or drying free and/or calender free manufacturing methods

According to an embodiment of the invention a negative electrode—heterofibrous silicon anode is provided where selected active material is heterofibrous ex-situ pre-lithiated and/or where the content of silicon in anode is ≥72% per wt. more preferably a 92% where more preferably the state of silicon anode pre-lithiation depends on the content of available lithium in cathode where together forming a well-balanced Li-ion cell.

According to an embodiment of the invention a negative electrode—heterofibrous silicon anode is provided where the size of fibers/rods/wires/tubes is between 120 nm-15 μm and where thickness of the heterofibrous silicon (wafer-like) anode is between 10 μm to 800 μm.

This and other dimensional specifications may be determined by SEM (Scanning electron microscopy)

According to an embodiment of the invention a method of preparation of a negative electrode—heterofibrous silicon anode is provided where silicon fibers are prepared from silicon precursor preferably with suitable dopant and/or dopants, preferably form a homogeneous mixture which is preferably partially co-polymerized prior to entering a fiber forming process.

The present invention may also be directed to a negative electrode for the use in an alkali-ion rechargeable battery, wherein an electrochemically active material of the anode is selected from the Group IV semiconductors characterized in that the active material is provided as a heterofibrous and/or wafer-like and/or self-standing and/or monolithic anode body, wherein the anode body comprises at least 2 layers of aligned and/or stacked and/or interlaced fibers which are spot-fused together at multiple discrete points by individual Li-Group-IV-semiconductor-alloy and/or lithium bonds between the layers and that the anode body, in particular the layers, are anisotropically lithiated.

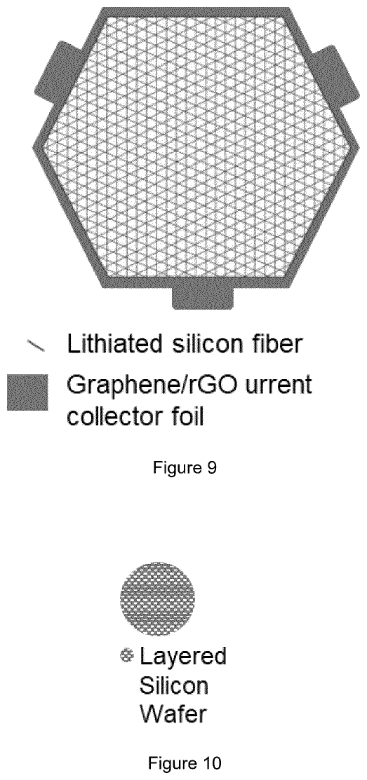

According to an embodiment a novel safety improving concept FIG. 9 of using beneficial anisotropic properties of 2D graphene foil aka paper is provided such as higher thermal and electronic conductivity in-plane direction than through plane so such net-shaped graphene current collector foil FIG. 8 with integrated current collector tab and or tabs which mimics the shape of electrode FIG. 7 due the anisotropy allow to efficiently remove and redistribute electron as well as remove heat from or to cell.

FIG. 10-13 depict model-like the influence of Lithium on the active mass material of the anode during construction of the anode.

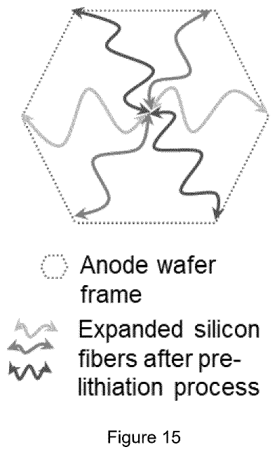

FIGS. 14 and 15 depict the influence of lithiation an de-lithiation on the structure of the anode layers (structural expansion and shrinking of the layers) between the fusing-spots in particular according to claim 1.

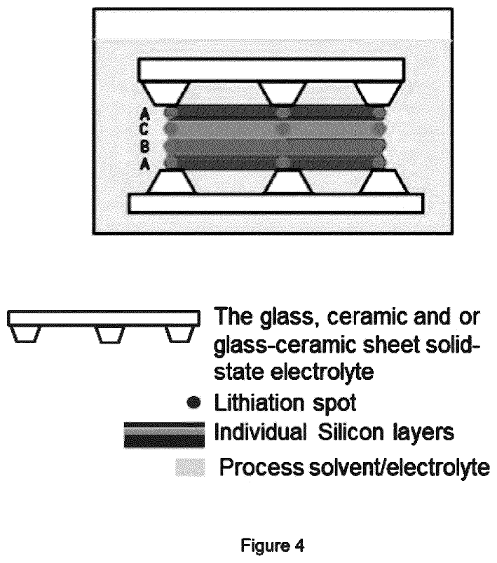

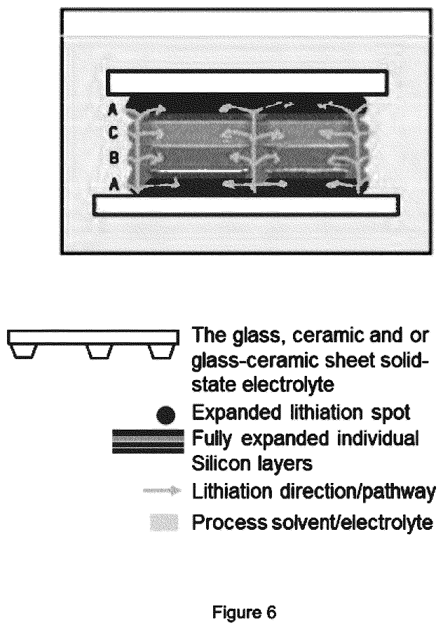

Preferably the monolithic and/or wafer-like and/or self-standing architecture further comprises at least 2, preferably at least 3 hetero-fibrous silicon layers stacked and/or interlaced FIG. 4, 5 between each layer wherein preferably such silicon structure is subsequently convertible into a monolithic body by lithiation FIG. 6.

The present invention may also be directed to a negative electrode for the use in an alkali-ion rechargeable battery, comprising an electrochemically active material of the anode and/or the active material is selected from the Group IV semiconductors and/or the active material is provided as a heterofibrous and/or wafer-like and/or self-standing and/or monolithic anode body and/or the anode body comprises at least 2 layers of aligned and/or stacked and/or interlaced fibers and/or the layers are spot-fused (FIGS. 1 and/or 2 and/or 3). Together at multiple discrete points by individual Li-Group-IV-semiconductor-alloy and/or lithium bonds and/or the layers are spaced apart from each other, preferably by the spot-fused bonds and/or the spot fused bonds are oriented in an out-of-plane direction with respect to the layer plane of extension, and/or the part of the layers which are outside of the spot-fused bond are free to move and/or expand within in-plane direction, and/or the anode body, in particular the layers, are anisotropically lithiated. Preferably the anode body has an artificial ex-situ SEI layer over the entire surface of anode body (wafer).

According to an embodiment of the invention a method of producing a negative electrode—heterofibrous silicon anode where anisotropic (over)-lithiation of silicon fiber layers is provided by a molten lithium print-fusing method preferably within the temperature range of 45° C.-750° C. via a melt printer and/or lithium dispenser, wherein the melt-printer head preferably follows a pre-defined trajectory to place fuse spots and preferably create functional anisotropy (anisotropic lithiation) at the anode defined as patterns or spots.

According to an embodiment of the invention a method of producing a negative electrode—heterofibrous silicon anode where anisotropic (over)-lithiation of the silicon fiber layers is provided e.g., by an electrochemical method preferably within the temperature range of suitable lithium electrolyte 100° C. to 250° C. in which the whole silicon anode body (wafer) is immersed. Glass, ceramic and or glass-ceramic sheet of solid-state electrolyte may divide operating pre-lithiation chamber into two independent cathode/anode compartment which allow to use various types of suitable Li+ sources such as molten lithium metal and or thick lithium metal foil and or liquid lithium rich donor electrolyte such as Li₂S₆ in organic solvents and or Li₂SO₄ in polar protic solvent such as water and Cu²⁺ sacrificial electrode. The glass, ceramic and or glass-ceramic sheet of solid-state electrolyte feature a pattern resembling the targeted distribution of the anisotropic lithiation (see FIGS. 2, 4, 5 and 6).

According to an embodiment of the invention a method of producing a negative electrode—silicon anode is provided, wherein the silicon fiber layers and/or the printer head is/are immersed into liquid processing medium(s). Preferably, each print-fusing head/nozzle are electrically connected to monitor local spot-area resistivity of the Si anode body (wafer) and/or to monitor pressure build-up during expansion occurring by pre-lithiation where those parameters is used in such way that well balanced spot-fused points is made. This allows safer and faster lithiation of Si along the printer/dosing heads/nozzles trajectory or spot printing/fusing. Preferably Li spot printing/fusing interconnects the individual Si fiber layers while as droplets of molten lithium preferably going up through the layers of silicon during the spot-fusing process.

According to an embodiment of the invention a method of ex-situ pre-lithiation (preferably in the first stage) negative electrode—heterofibrous silicon anode is provided wherein the flow of molten lithium towards the solvent immersed silicon layers is against gravity—defined as floating inside a suitable processing liquid, such as hydrocarbons as outlined above which is compatible with molten lithium and where the density of such liquid is ≥0.65 g/cm3, thus higher than the density of the molten lithium. Preferably according to the present in invention a negative electrode for the use in alkali-ion rechargeable battery is claimed where electrochemically active material is selected from the Group IV semiconductors, the active material forming a heterofibrous monolithic anode body, the anode body comprises at least 3 layers of aligned and/or stacked and/or interlaced fibers.

In the following, the present invention will be further explained by the provided figures.

In the figures it is shown:

FIG. 1 an example of a fuse spot distribution to interconnect separate layers of aligned and/or stacked and/or interlaced group IV, in particular silicon fibres,

FIG. 2 an exemplary set up for lithiation of the spot fused layered silicon anode body (wafer), patterned solid state (glass)-ceramic electrolyte (hexagonal) as-lithiation mask. The lithiation takes place in steps, e.g., as depicted in FIG. 2 in four steps, however it is not limited on this number of steps. Steps can be in between 1-100 steps. lithiation is 1^{st} started preferably in the centre part 1 followed by the subsequent area to then 3 then 4 and so on.

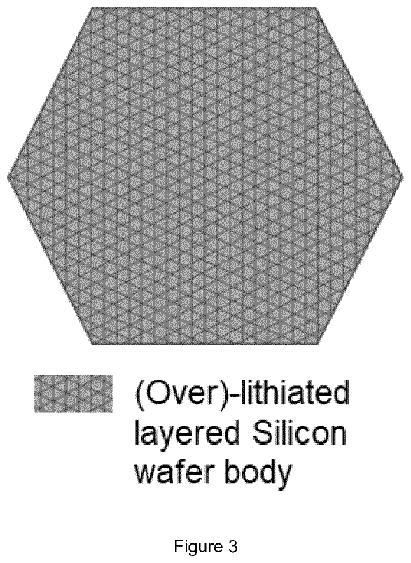

FIG. 3 an abstract image of an over-lithiated silicon anode body,

FIG. 4 Patterned solid state (glass)-ceramic electrolyte as-lithiation mask resembling the ex-situ lithiation in a process solvent/electrolyte. FIG. 4 depicts the initial state with only limited lithiation and unexpanded silicon layers which are mechanically interlocked between each other by the fused spots.

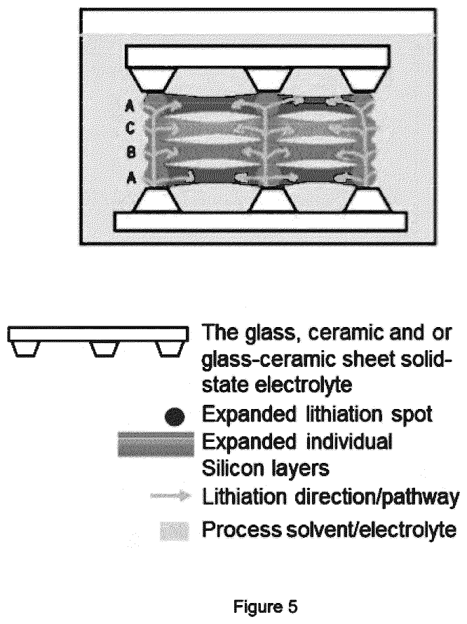

FIG. 5 Patterned solid state (glass)-ceramic electrolyte as-lithiation mask resembling the ex-situ lithiation in a process solvent/electrolyte. FIG. 5 depicts the intermediate state with partly lithiation and expanded silicon layers, which are anisotropically spot fused by lithium induced metallurgic bonds. The arrows mark the lithiation pathway,

FIG. 6 Patterned solid state (glass)-ceramic electrolyte as-lithiation mask resembling the ex-situ lithiation in a process solvent/electrolyte. FIG. 6 depicts the complete state with (over)-lithiation and fully expanded silicon layers, which are anisotropically spot fused by lithium induced metallurgic bonds. The arrows mark the lithiation pathway.

FIG. 7 Lithiated (5-100%) silicon wafer monolithic body, including ex-situ fabricated artificial SEI layer,

FIG. 8 Graphene and/or reduced graphene oxide current collector foil including 3 tabs,

FIG. 9 Lithiated (5-100%) silicon wafer anode monolith, including ex-situ fabricated artificial SEI layer attached on top of a graphene and/or reduced graphene oxide current foil including 3 tabs,

FIG. 10-13 show the relative volumetric extent of the layered silicon anode (late silicon wafer) in the different non-lithiated, partially lithiated and over lithiated states. the size of the circles may only represent the increase in volume but not necessarily the actual percentage in volume or die me to increase,

FIG. 10 Silicon wafer anode in the state of the highest density,

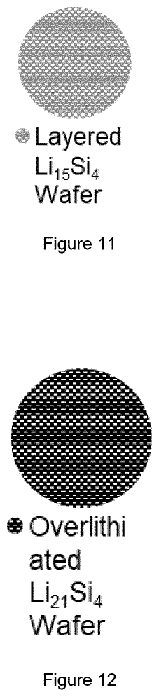

FIG. 11 (Electrochemical) lithiated silicon wafer anode in the state of room temperature active phase Li₁₅Si₄,

FIG. 12 (Electrochemical) over-lithiated silicon wafer anode in the state of the high temperature active phase Li₂₁Si₅ featuring the maximum possible volume,

FIG. 13 Ex-situ fabricated SEI via the disproportionation of the high temperature Li₂₁Si₅ phase to the room temperature phase Li₁₅Si₄. The such released excess of Li is consumed to build up the artificial SEI layer (red),

FIG. 14 a top view on the relative orientation of 3 representative layers with aligned silicon fibres each alignment along the direction of the individual arrows of the same colour Layers of aligned and preferably 120° interlaced silicon fibers before pre-lithiation process,

FIG. 15 the setup of layers according to FIG. 14 after the pre-lithiation (spot fusing) process.

1. A negative electrode for the use in an alkali-ion rechargeable battery, comprising:
an electrochemically active material of the anode,
wherein the active material is selected from the Group IV semiconductors,
wherein the active material is provided as a heterofibrous wafer-like self-standing monolithic anode body,
wherein the anode body comprises at least 2 layers of aligned and/or stacked and/or interlaced fibers,
wherein the at least two layers are arranged parallel on top of each other,
wherein the layers are interconnected at multiple discrete interconnection sites via metallurgical bonds,
wherein the metallurgical bonds comprise or consist of Li-Group-IV-semiconductor-alloy and/or lithium or a mixture of the two,
wherein the discrete interconnection sites are spread across the anode body, hence discretely distributed over the area of the layers,
and wherein the metallurgical bonds extend in an out-of-plane direction with respect to the individual layers and are spacers between the layers.

2. Negative electrode according to claim 1, characterized in that the anode body is unevenly lithiated with non-lithiated and/or deficiently lithiated and/or stoichiometrically lithiated areas.

3. Negative electrode according to claim 1, characterized in that the anode body has an artificial ex-situ introduced SEI layer over the entire surface of wafer the volume/extension of which is adapted to the volume of the anode in the maximum lithiated state and/or which is provided in a highly lithiated state of the anode that is higher than Li₁₅Si₄.

4. Negative electrode according to claim 1, characterized in that the Group IV semiconductor is silicon or comprises silicon.

5. Negative electrode according to claim 1, characterized in that at the discrete points of interconnection of the layers a stoichiometric access of lithium is located with respect to the amount of lithium needed to form a Li-Group-IV-semiconductor-alloy within the metallurgical bond.

6. Negative electrode according to claim 1, characterized in that the length of fibers is between 120 nm-15 μm and where thickness of the heterofibrous silicon wafer like anode is between 10 μm to 800 μm.

7. Negative electrode according to claim 1, characterized in that the individual Li-Group-IV-semiconductor-alloy bonds, thus the discrete points of interconnection, are provided as placeholders between the layers such that the layers experience at least partially a void between them at least in a discharged state, wherein the voids are at least partially filled with the active material in a charged state of the anode.

8. Negative electrode according to claim 1, characterized in that the discrete interconnection points or sites are in the shape of dots and/or lines and/or pillars and/or patches.

9. Negative electrode according to claim 1, characterized in that the layers are spaced apart from each other.

10. Negative electrode according to claim 1, characterized in that the discrete interconnection sites are at least partially located between the layers as spacers and accordingly the layers comprise at least some areas with a gap between them provided by the spacer.

11. Method of manufacture of the anode body according to claim 1, wherein at least one group IV semiconductor material is provided as individual layers of aligned and/or stacked and/or interlaced fibers, wherein the layers are arranged parallel to each other and spot-fused together, namely interconnected at multiple discrete interconnection sites via metallurgical bonds the metallurgical bonds that comprise or consist of Li-Group-IV-semiconductor-alloy and/or lithium or a mixture of the two and are formed by fusing the layers together by Li fusing or introduction of lithium in the liquid state into the arranged layers, wherein the discrete interconnection sites are introduced across the anode body, hence discretely distributed over the area of the layers, and wherein the metallurgical bonds are provided in such a way that they extend in an out-of-plane direction with respect to the individual layers and thus form spacers between the layers.

12. Method of manufacture of the anode body according to claim 10, characterized in that the anode body is lithiated to an over-lithiated state, namely Li₂₁X₅, wherein X is at least one of the group IV semiconductor elements, and treated with one or several SEI-layer forming dopants, such as As-, P-, (H)F-compounds and/or an SEI-layer forming electrolyte, wherein an artificial SEI-layer is formed on an anode in its maximum volumetric expansion state.
